(19) United States
(12) Patent Application Publication
(10) Pub. No.: US 2007/0127630 A1
(43) Pub. Date: Jun. 7, 2007

(54) Exchange system, and method for providing maintenance processing result to be used in exchange system

(75) Inventor: Fumio Shibasaki, Sagamihara-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/585,930

(22) Filed: Oct. 25, 2006

(30) Foreign Application Priority Data
Oct. 27, 2005 (JP) 2005-313302

(51) Int. Cl. H04M 3/08; H04M 3/22; H04M 1/24

(52) U.S. Cl. 379/9.02

(57) ABSTRACT

According to one embodiment, an exchange system includes a computer includes a memory which stores a table in which the first display control data is associated with second display control data more detailed in comparison to the first display control data for each of the maintenance function, and a first transmitter which refers to the table based on the first display control data, and transmits the second display control data corresponding to the first display control data to the telephone exchange apparatus based on the reference result, and the telephone exchange apparatus includes a second transmitter which transmits an acquiring request for the second display control data to the computer, and a controller which receives the second display control data from the computer in response to the transmission of the acquiring request to display the second display control data onto the display unit of the first telephone terminal.

### CROSS-REFERENCE TO RELATED APPLICATIONS

This application is based upon and claims the benefit of priority from Japanese Patent Application No. 2005-313302, filed Oct. 27, 2005, the entire contents of which are incorporated herein by reference.

### BACKGROUND

1. Field

One embodiment of the invention relates to an exchange system having a function of executing a maintenance operation processing regarding an exchange processing to, for instance, a telephone exchange apparatus by using a telephone terminal, and relates to a method for providing a maintenance processing result to be used in the exchange system.

2. Description of the Related Art

A telephone exchange apparatus for, such as a key telephone set requires reliability to normally operate a telephone terminal whenever a handset is lifted, even in emergency, except the case of an excess of predetermined traffic and the like. Therefore, as the occasion demands, monitoring the reliability whether or not the exchange system is normally operated has to be made. As one of them, monitoring a change in a system clock, confirming transmission normalcy inter-telephone terminal or between the telephone terminal and a station line, authentication whether a trunk board may be used normally or not, etc., is a possible approach.

Conventionally, in such case, the exchange system connects a maintenance terminal to the exchange apparatus to display the operation state of the exchange apparatus onto a monitor screen and allows a maintenance person to monitor the operation state of the exchange apparatus by monitoring the display result.

However, the maintenance person is not always stationed near by the exchange apparatus and also the maintenance terminal is not always ensured. Accordingly, the system also requires enabling the telephone terminal to conduct the maintenance operation. However, the maintenance operation from the telephone terminal causes restrictions on the data concerning to the easiness to a user, such as the display result and guidance due to the restrictions on a user interface or the like. As a result, a heavy burden on the user, such that the user of the telephone terminal is needed to get skillful and technical knowledge, has been imposed.

In the case in which a user interface for a maintenance function from the telephone terminal is changed owing to an addition of a new maintenance function, since a software stored in a memory in the exchange apparatus should be changed into a renewal software corresponding to the new maintenance function, it keeps the user long in updating the software. And further, it causes the user inconvenience, such that the system has to stop itself during the change in the software.

Meanwhile, a technique, which allows a manager side to easily determine whether a communication is related to a command response character string or to alarm information by making a conversion between a human interface (character string) unique to a maintenance object and a standard protocol (common management information protocol (CMIP)) between the maintenance object and a management function and by making a communication, has been disclosed (for instance, Jpn. Pat. Appln. KOKAI Publication No. 2001-14241).

The foregoing technique however converts a protocol but does not convert data in the same protocol, so that more memory capacity and processing ability are required to achieve the technique.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of an exchange system regarding a first embodiment of the present invention;

FIG. 2 is an exemplary block diagram showing a functional configuration of a computer shown in FIG. 1;

FIG. 3 is an exemplary view showing one example of a stored content in a key management table shown in FIG. 2;

FIG. 4 is an exemplary view showing one example of a stored content in a display conversion table shown in FIG. 2;

FIG. 5 is an exemplary block diagram showing a functional configuration of a central control unit shown in FIG. 1;

FIG. 6 is an exemplary sequence view showing transmitting/receiving operations of information among a telephone terminal, a master apparatus and the computer in conducting a maintenance operation processing in the first embodiment;

FIG. 7 is an exemplary flowchart of a control processing procedure of the central control unit in receiving an operation key in the first embodiment;

FIG. 8 is an exemplary flowchart showing a control processing procedure of the central control unit in displaying an execution result of the maintenance operation processing in the first embodiment;

FIG. 9 is an exemplary block diagram showing a configuration of an exchange system regarding a second embodiment of the present invention; and

FIG. 10 is an exemplary flowchart showing a control processing procedure of a central control unit in displaying an execution result of a maintenance operation processing in the second embodiment.

### DETAILED DESCRIPTION

Various embodiments according to the invention will be described hereinafter with reference to the accompanying drawings. In general, according to one embodiment of the invention, an exchange system, comprising a telephone exchange apparatus which executes an exchange processing between a first telephone terminal having a display unit and a second telephone terminal different from the first telephone terminal, and executes a maintenance function selected by making a maintenance executing unit treat the operation information to display first display control data representing the execution result onto a display unit of the first telephone terminal, when operation information so that the first telephone terminal generates operation function, the operation function to selectively execute an arbitrary maintenance function among a plurality of maintenance functions deferring from one another and also regarding a maintenance operation of the exchange processing, and a computer connected to the telephone exchange apparatus, wherein the computer comprises: a maintenance memory which stores a maintenance management table in which the first display control data is associated with second display control data more detailed in comparison to the first display control data for each of the maintenance function; and a first transmitter which refers to the maintenance management table based on the first display control data, and transmits the second display control data corresponding to the first display control data to the telephone exchange apparatus based on the reference result, when an acquiring request for the second display control data including the first display control data is transmitted from the telephone exchange apparatus, and the telephone exchange apparatus comprises: a second transmitter which transmits an acquiring request for the second display control data to the computer prior to a transmission of the first display control data to the first telephone terminal; and a controller which receives the second display control data from the computer in response to the transmission of the acquiring request to display the second display control data onto the display unit of the first telephone terminal.

### First Embodiment

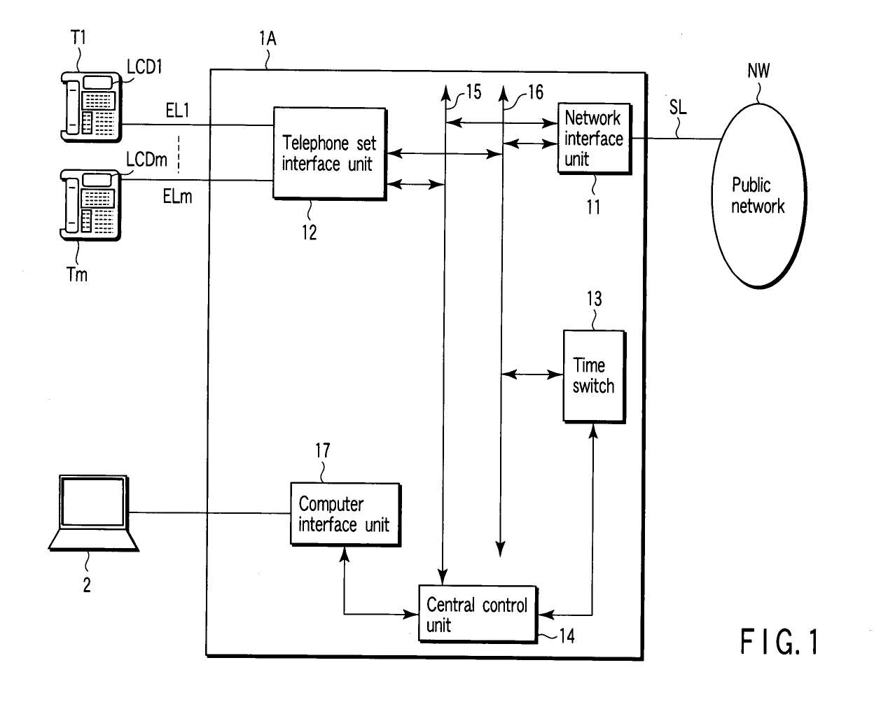

FIG. 1 is a block diagram showing a configuration of an exchange system regarding a first embodiment of the present invention and a symbol 1A indicates a master apparatus as a telephone exchange apparatus.

The master apparatus 1A has a network interface unit 11, a telephone set interface unit 12, a time switch 13 and a central control unit 14, and these units are connected with one another via a control bus 15. The network interface unit 11, the telephone interface unit 12 and the time switch 13 are connected with one another via a voice bus 16.

The network interface unit 11 is connected to a public network NW via a station line SL to establish a call to and from the public network NW.

The telephone set interface unit 12 houses a plurality of extensions EL1-ELm and telephone terminals T1-Tm are connected to the extensions EL1-ELm, respectively. For instance, digital key telephone sets are used as the telephone terminals T1-Tm which have display units LCD1-LCDm, respectively. The telephone set interface unit 12 performs transmission/reception processings and transmission processings or the like of digital signals to the telephone terminals T1-Tm.

The time switch 13 follows an instruction from the central control unit 14 to conduct channel exchange of the digital signals transmitted between the network interface unit 11 and the telephone set interface unit 12 via the voice bus 16.

By the way, a computer interface unit 17 is built in the master apparatus 1A of the first embodiment. A computer 2 is connected to the computer interface unit 17. The computer interface unit 17 has a function to conduct a transfer processing of a control command, etc., between the computer 2 and the central control unit 14.

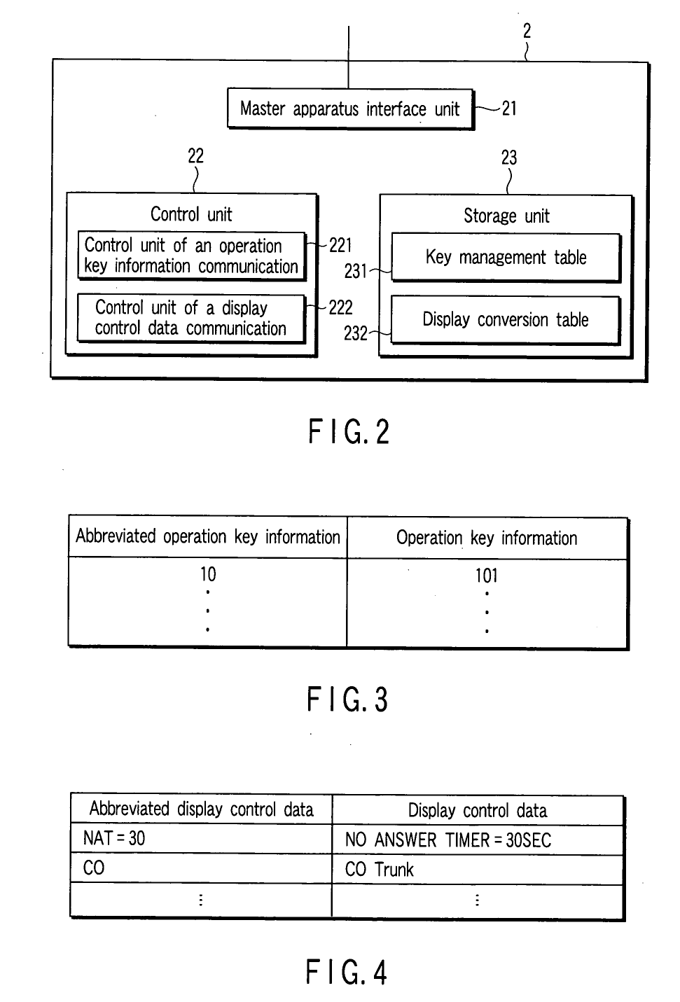

FIG. 2 is a block diagram showing a functional configuration of the computer 2.

The computer 2 has a master apparatus interface unit 21, a control unit 22 and a storage unit 23. Among of them, the master apparatus interface unit 21 performs an interface processing to and from the master apparatus 1A.

The storage unit 23 is provided with a key management table 231 as an operation management table and a display conversion table 232 as a maintenance management table. The key management table 231 stores, as shown in FIG. 3, data representing a correspondence relationship between operation key information (maintenance command number) to execute an arbitrary operation processing of the master apparatus 1A by the telephone terminals T1-Tm and abbreviated operation key information to specify the operation key information when the operation keys of the telephone terminals T1-Tm are depressed. Wherein, FIG. 3 shows an example in the case in which there is only a number 101 in a range of number 100 to 199 of the maintenance command numbers.

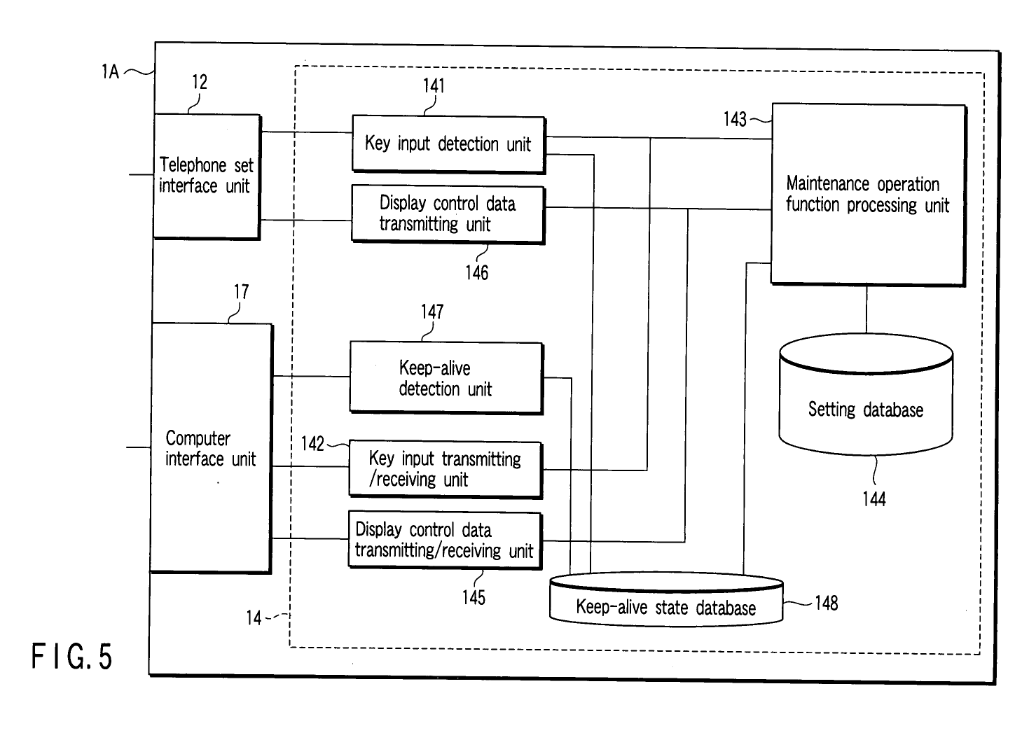

The display conversion table 232 stores, as shown in FIG. 4, data sowing a correspondence relationship between abbreviated display control data representing the execution result of the maintenance operation processing by the master apparatus 1A and display control data more detailed than the abbreviated display control data.

On the other hand, the control unit 22 has a control unit of an operation key information communication 221 (hereinafter, referred to as control unit 221) and a control unit of a display control data communication 222 (hereinafter, referred to as control unit 222) in addition to a control function to achieve operations as the computer 2.

The control unit 221 makes a communication with the master apparatus 1A, receives the abbreviated operation key information transmitted from the master apparatus 1A, and reads out the operation key information corresponding to the abbreviated operation key information from the key management table 231 to transmit the operation key information to the master apparatus 1A.

The control unit 222 makes a communication with the master apparatus 1A, receives an acquiring request for the display control data including the abbreviated display control data transmitted from the master apparatus 1A, and reads out the display control data corresponding to the abbreviated display control data from the display conversion table 232 to transmit the display control data to the master apparatus 1A.

FIG. 5 is a block diagram showing a functional configuration of the central control unit 14.

In other words, the central control unit 14 includes a key input detection unit 141 (hereinafter, referred to as detection unit 141), a key input transmitting/receiving unit 142 (hereinafter, referred to as transmitting/receiving unit 142), a maintenance operation function processing unit 143 (hereinafter, refereed to as processing unit 143), a setting database 144, a display control data transmitting/receiving unit 145 (hereinafter, referred to as transmitting/receiving unit 145), a display control data transmitting unit 146 (hereinafter, referred to as transmitting unit 146), a keep alive detection unit 147 (hereinafter, referred to as detection unit 147), and a keep alive state database 148.

For instance, when an operation key “10” is depressed at the telephone terminal T1, the detection unit 141 detects the operation key information “10” of the depressed operation key “10”. And if the fact of a continuation of the keep-alive state is stored on the keep-alive state database 148, the detection unit 141 transfers the operation key information “10” to the transmitting/receiving unit 142.

The transmitting/receiving unit 142 makes a communication with the computer 2 via the computer interface unit 17, transmits the operation key information “10”, and transfers operation key information “101” converted by the computer 2 to the processing unit 143.

The processing unit 143 executes a reference and operation of the setting database 144 depending on the input operation key information “101”. And if the fact of the continuation of the keep-alive state is stored in the keep-alive state database 148, the processing unit 143 transfers the abbreviated display control data showing the execution result to the transmitting/receiving unit 145.

The transmitting/receiving unit 145 performs a communication with the computer 2 via the computer interface unit 17, transmits an acquiring request for the display control data including the abbreviated display control data to the computer 2, and receives the display control data transmitted from the computer 2 in response to the acquiring request to transfer it to the transmitting unit 146.

The transmitting unit 146 transmits the display control data transmitted from the transmitting/receiving unit 145 to the telephone terminal T1 to be a request origin via the telephone set interface unit 12 and displays the display control data onto the LCD1 of the telephone terminal T1.

The detection unit 147 periodically transmits a keep-alive signal as a monitoring signal to the computer 2 to monitor whether or not the central control unit 14 can receive a response signal returned from the computer 2. Then, the detection unit 147 monitors a trouble occurrence resulted from the connection to the computer 2, and writes the monitoring result into the keep-alive state database 148.

Next, operations of the exchange system configured in a manner mentioned above will be described.

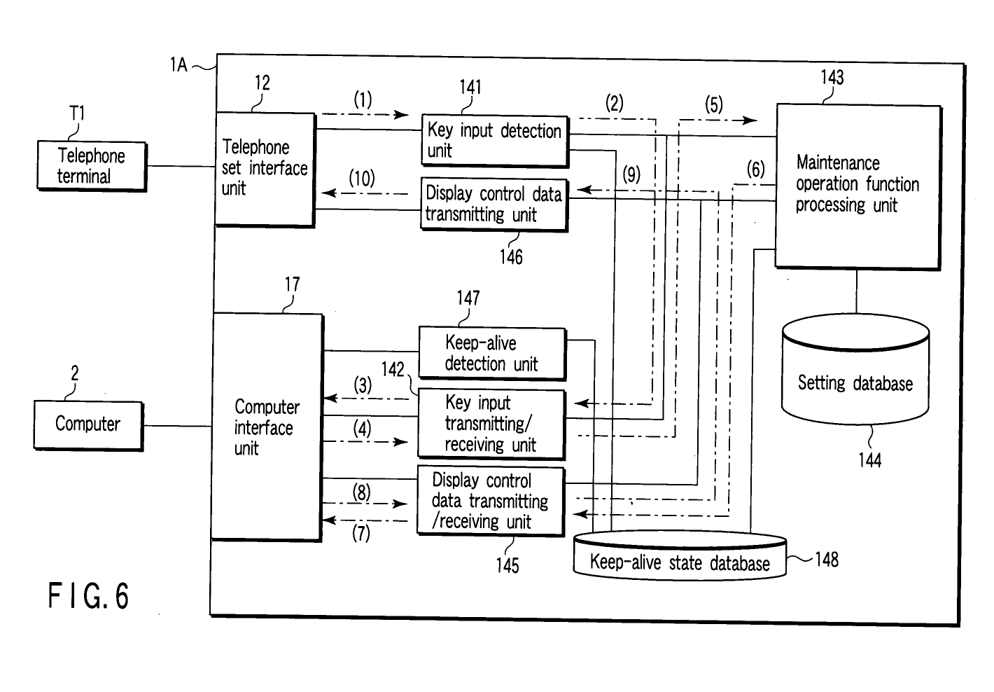

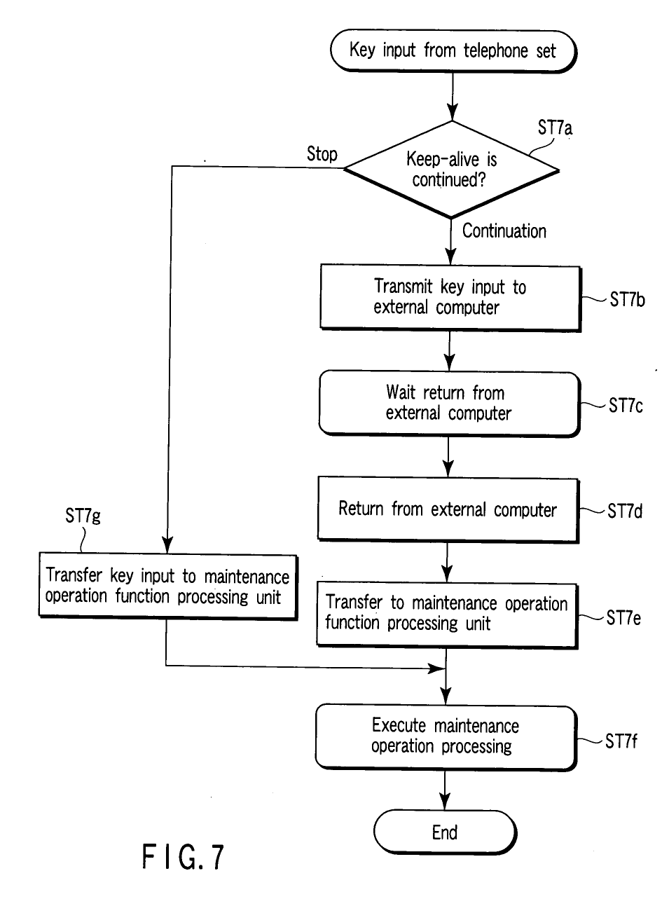

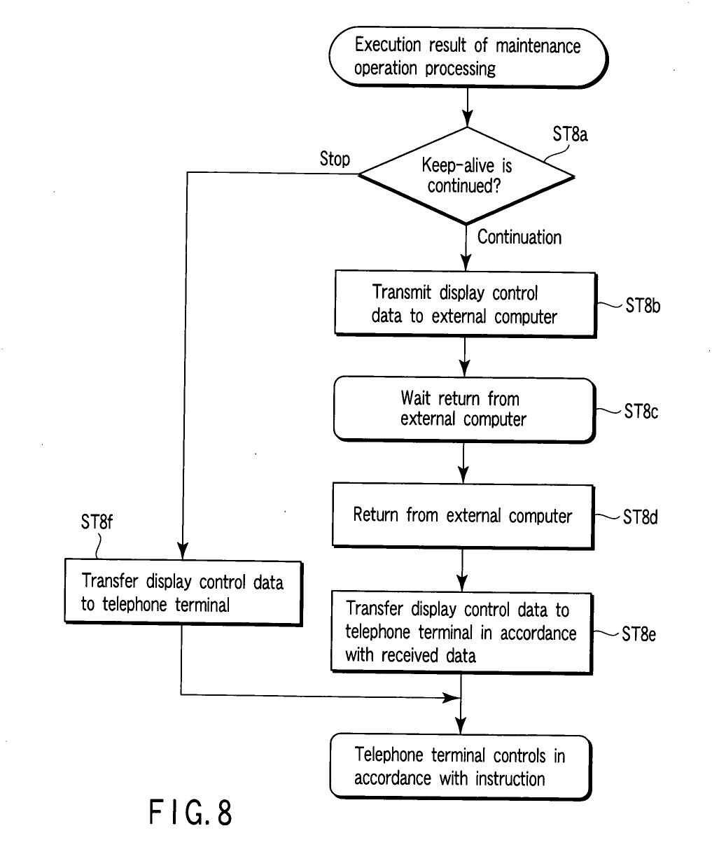

FIG. 6 is a sequence view expressing the transmitting/receiving operations of the information among the telephone terminal T1, the master apparatus 1A and the computer 2. FIG. 7 is a flowchart illustrating the control processing procedure of the central control unit 14 in receiving the operation key. FIG. 8 is a flowchart illustrating the control processing procedure of the central control unit 14 in displaying the execution result of the maintenance operation processing onto the telephone terminal T1.

For example, it is presumed that the user of the telephone terminal T1 depresses the operation key “10” so as to request a display of a no answer time to transfer an incoming call directed to the telephone terminal T1 to a voice mail device. The telephone terminal T1 then transmits the operation key information to the master apparatus 1A.

The central control unit 14 of the master apparatus 1A then detects a key input from the telephone unit T1 by means of the detection unit 141 ((1) in FIG. 6) to determine whether or not the information on the fact of the continuation of the keep-alive is stored in the keep-alive state database 148 (block ST7a).

Here, if the information on the fact of the continuation thereof is stored therein, the central control unit 14 shifts from the block ST7a to a block ST7b to transmit the operation key information “10” to the computer 2 there ((3) in FIG. 6) through the transmitting/receiving unit 142 ((2) in FIG. 6).

The computer 2 which has received the operation key information reads out the operation key information “101” corresponding to the operation key information “10” by referring to the key management table 231 to return the operation key information “101” to the main apparatus 1A.

In contrast to this, the central control unit 14 monitors the arrival of the operation key information from the computer 2 (block ST7c). In this situation, when receiving the operation key information “101” from the computer 2 ((4) in FIG. 6), the central control unit 14 shifts from a block ST7d to a block ST7e and transfers the operation key information “101” there through the transmitting/receiving unit 142 to the processing unit 143 ((5) in FIG. 6).

The processing unit 143 analyses the operation key information “101” to read out the abbreviated display control data showing a no answer time value “NAT=30” for transferring an incoming call to the voice mail device set at the telephone terminal T1 from the setting database 144 in accordance with the operation key information “101” (block ST7f). The master apparatus 1A internally abbreviates the characters up to the shorted length by which its meaning may be understood to transmit data to display the time value “NAT=30”.

Next to this, the central control unit 14 determines whether or not the information of the fact of the continuation of the keep-alive is stored in the keep-alive state database 148 (block ST8a). And if the keep-alive state database 148 shows the continuation of the keep-alive, the central control unit 14 shifts to the block ST8b to transfer the acquiring request for the display control data including the abbreviated display control data there to the transmitting/receiving unit 145 ((6) in FIG. 6). The central control unit 14 then makes the transmitting/receiving unit 145 transmit the acquiring request to the computer 2 ((7) in FIG. 6).

The computer 2 which has received the acquiring request, referees to the display conversion table 232 to reads out display control data “NO ANSWER TIMER=30 SEC” corresponding to the abbreviated display control data “NAT=30” then returns the display control data to the master apparatus 1A.

In contrast to this, the central control unit 14 monitors the arrival of the display control data from the computer 2 (block ST8c). In this state, when receiving the display control data from the computer 2 ((8) in FIG. 6), the central control unit 14 makes a shift from the block ST8d to the block ST8e, transfers the display control data there to the transmitting unit 146 ((9) in FIG. 6) then transmits it to the telephone terminal T1 through the telephone set interface 12 ((10) in FIG. 6).

Thus, the display unit LCD1 of the telephone terminal T1 results in displaying the non-confusing timer value that is “NO ANSWER TIMER=30 SEC”.

In the block ST7a, in the case of the discontinuation of the keep-alive, the central control unit 14 stores the information on the fact of the discontinuation state into the keep-alive state database 148. The central control unit 14 then directly transfers the operation key information from the detection unit 141 to the processing unit 143 (block ST7g).

On the other hand, also in the block 8a, the central control unit 14 stores the information on the fact of the discontinuation state into the keep-alive state data base 148 to directly transfer the display control data from the processing unit 143 to the transmitting unit 146 (block ST8f).

It is supposed that the user inputs a changing instruction by means of the operation key so as to change the no answer time information from “30” to “45” in the state in which the time value “NO ANSWER TIMER=30 SEC” is displayed on the display unit LCD1 of the telephone terminal T1. The central control unit 14 of the master apparatus 1A then rewrites the no answer time value set at the telephone terminal T1 in the setting database 144 from “30” to “45” in accordance with the foregoing procedure. When completing the change in the setting database 144, the central control unit 14 returns a massage with “normal” inserted therein to the telephone terminal T1 as the request origin.

As mentioned above, in the first embodiment, the display conversion table 232 in which the abbreviated display control data and the display control data for each maintenance function are brought into the correspondence relationship is provided for the computer 2. In the case where the telephone terminal T1 conducts the maintenance operation processing for the master apparatus 1A, the computer 2 shares to execute the control processings related to the maintenance operation without depending on the master apparatus 1A.

Accordingly, depending on the shared execution, without overweighting the memory capacity of the setting database 144 in the master apparatus 1A followed by the addition of the display conversion function, the exchange system becomes possible to provide the execution result of the maintenance operation processing easy to be understood for the telephone terminals T1-Tm performing the maintenance processings. And furthermore, the exchange system can conduct the addition of the maintenance operation function inexpensively.

In changing the user interface, since the exchange system requires only a renewal of a stored content in the storage unit 23 of the computer 2, it does not need to stop the operation of the master apparatus 1A.

The provision of the key management table 231 for the computer 2 in the first embodiment enables the computer 2 to specify the operation key information with reference to the key management table 231 when the abbreviated operation key information occurs in the telephone terminal T1. Thereby, exchange system may dramatically simplify the operations for the maintenance operation.

Moreover, in the first embodiment, even in a case in which any trouble has occurred in the computer 2, the exchange system automatically switches over to the maintenance processing implemented by the master apparatus 1A, the switching over results in the continuation of the maintenance processing.

### Second Embodiment

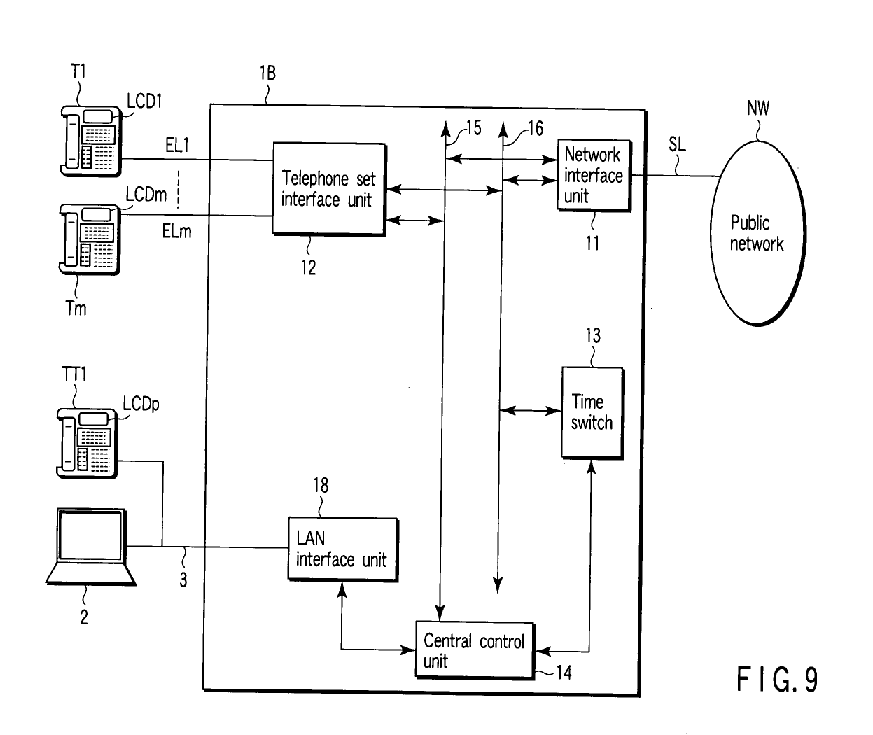

FIG. 9 is a block diagram illustrating an exchange system regarding a second embodiment of the present invention. In FIG. 9, the identical components to those of FIG. 1 are designated at the identical reference symbols and are not described in detail.

A master apparatus 1B has a local area network (LAN) interface unit 18 built-in. The LAN interface unit 18A is connected to a LAN 3. The LAN 3 connects the computer 2 and the telephone terminal TT1.

Next, operations of the exchange system configured in such a manner will be described.

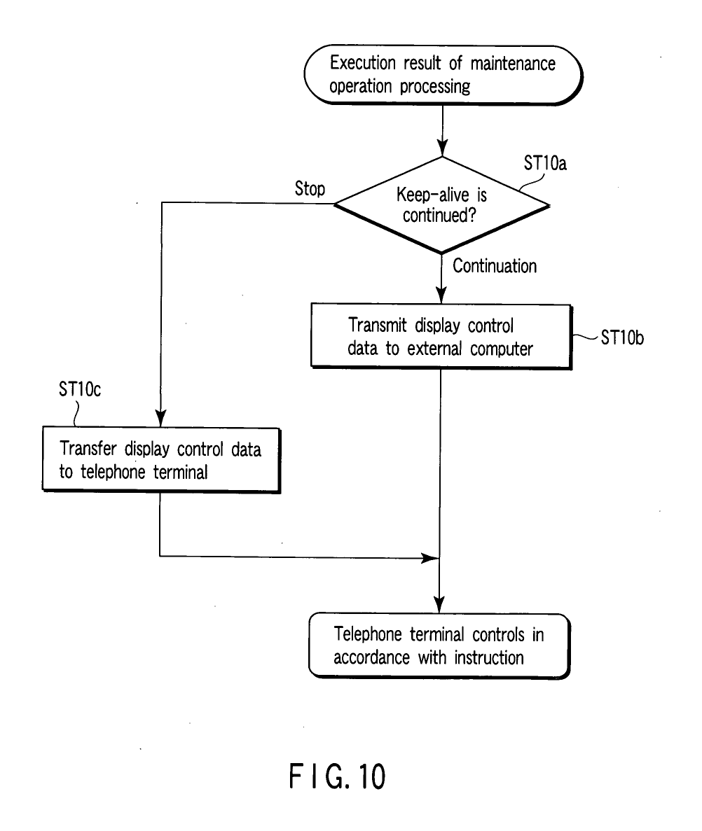

FIG. 10 is a flowchart illustrating a control processing procedure of the central control unit 14 in displaying an execution result from a maintenance operation processing to the telephone terminal T1.

For example, it is assumed that a user of the telephone terminal TT1 depresses the operation key “10” in order to request for a display of a no answer time to transfer an incoming call directed to the telephone terminal TT1 to the voice mail device. Then, the telephone terminal TT1 transmits operation key information to the computer 2 via the LAN 3.

The computer 2 that has received the operation key information reads out operation key information “101” corresponding to the operation key information “10” with reference to the key management table 231 to transmit the operation key information “101” to the master apparatus 1B.

The central control unit 14 determines whether or not the keep-alive state database 148 has stored the information on the fact of the keep-alive continuation (block ST10a). If the keep-alive state data base 148 has stored it therein, the central control unit 14 shifts to a block ST10b and transfers there an acquiring request for display control data including abbreviated display control data to the display control data transmitting/receiving unit 145 to make it transmit the acquiring request to the computer 2. The acquiring request includes a message representing the fact that the display control data should be directly transmitted to the telephone terminal TT1.

The computer 2 which has received the acquiring request reads out the display control data corresponding to the abbreviated display control data by referring to the display conversion table 232 to transmit it to the telephone terminal TT1 via the LAN 3.

Thus, above-mentioned processing results in that a display unit LCDp of the telephone terminal TT1 displays a timer value which is not confusable.

In the block ST10a, in the case of a discontinuation of the keep-alive, the central control unit 14 stores the information on the fact of the discontinuation into the keep-alive state data base 148 and directly transfers the display control data from the processing unit 143 to the telephone terminal TT1 (block ST10c).

As described above, in the second embodiment, in the case in which the computer 2 and the telephone terminal TT1 are connected to the LAN 3, the central control unit 14 may directly transfer the detailed execution result of the maintenance operation processing from the computer 2 to the telephone terminal TT1 by the use of the LAN 3. Therefore, the master apparatus 1B may leave out the function to receive the display control data from the computer 2 and the function to transfer the display control data to the telephone terminal TT1. Thereby, the processing burden on the master apparatus 1B may be reduced.

### Other Embodiment

The present invention is not limited to the aforementioned respective embodiments. For instance, the second embodiment having described the example in which a LAN connects between a master apparatus and a computer, the present invention is not limited to such example, and the connecting of them via a communication network such as a wide area network (WAN) is a possible approach.

Other than this, concerning to the configuration of the exchange system, the types of the telephone exchange apparatus (not limited to master apparatus but PBX is acceptable) and the telephone terminal, the type and configuration of the computer, the stored content of each table, the type of the maintenance operation function to be executed, the method for providing the execution result of the maintenance operation processing, and the like also may be embodied with various modifications without departing from the principle point of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An exchange system, comprising a telephone exchange apparatus which executes an exchange processing between a first telephone terminal having a display unit and a second telephone terminal different from the first telephone terminal, and executes a maintenance function selected by making a maintenance executing unit treat the operation information to display first display control data representing the execution result onto a display unit of the first telephone terminal, when operation information so that the first telephone terminal generates operation function, the operation function to selectively execute an arbitrary maintenance function among a plurality of maintenance functions deferring from one another and also regarding a maintenance operation of the exchange processing, and a computer connected to the telephone exchange apparatus, wherein
the computer comprises:
a maintenance memory which stores a maintenance management table in which the first display control data is associated with second display control data more detailed in comparison to the first display control data for each of the maintenance function; and
a first transmitter which refers to the maintenance management table based on the first display control data, and transmits the second display control data corresponding to the first display control data to the telephone exchange apparatus based on the reference result, when an acquiring request for the second display control data including the first display control data is transmitted from the telephone exchange apparatus, and
the telephone exchange apparatus comprises:
a second transmitter which transmits an acquiring request for the second display control data to the computer prior to a transmission of the first display control data to the first telephone terminal; and
a controller which receives the second display control data from the computer in response to the transmission of the acquiring request to display the second display control data onto the display unit of the first telephone terminal.

2. The exchange system according to claim 1, wherein the computer further comprises:
an operation memory which stores an operation management table in which the operation information is associated with abbreviated operation information specifying the operation information, when at least one operation key provided for the first telephone terminal is operated; and
a third transmitter which refers the operation management table based on the abbreviated operation information and transmits operation information corresponding to the abbreviated operation information to the telephone exchange apparatus based on the reference result, when the abbreviated operation information is transmitted from the telephone exchange apparatus, and
the telephone exchange apparatus further comprises:
a fourth transmitter which transmits the abbreviated operation information to the computer when the abbreviated operation information is generated from the first telephone terminal; and
a transfer unit which transfers operation information transmitted from the computer to the maintenance execution unit.

3. The exchange system according to claim 1, wherein
the telephone exchange apparatus further comprises;
a detector which detects a trouble resulted from a connection to the computer; and
a trouble responder which displays the first control data onto the display unit of the first telephone terminal, when the trouble is detected from the detection result of the detector.

4. The exchange system according to claim 1, when the computer is connected to the telephone exchange apparatus via a communication network and also a third telephone terminal deferring from the first and the second telephone terminals and each having display units is connected to the communication network, wherein the first transmitter transmits the second display control data to be displayed onto the display unit of the third telephone terminal to the third telephone terminal via the communication network.

5. A method for providing a maintenance processing result of an exchange system, comprising a telephone exchange apparatus which executes an exchange processing between a first telephone terminal having a display unit and a second telephone terminal different from the first telephone terminal, and executes a maintenance function selected by making a maintenance executing unit treat the operation information to display first display control data representing the execution result onto a display unit of the first telephone terminal, when operation information so that the first telephone terminal generates operation function, the operation function to selectively execute an arbitrary maintenance function among a plurality of maintenance functions deferring from one another and also regarding a maintenance operation of the exchange processing, and a computer connected to the telephone exchange apparatus, the method comprising:
storing a maintenance management table in which the first display control data is associated with second display control data more detailed in comparison to the first display control data for each of the maintenance function;
transmitting an acquiring request for the second display control data to the computer prior to a transmission of the first display control data to the first telephone terminal in the telephone exchange apparatus;
referring to the maintenance management table based on the first display control data to transmit the second display control data corresponding to the first display control data to the telephone exchange apparatus based on the reference result in the computer, when an acquiring request for the second display control data including the first display control data is transmitted from the telephone exchange apparatus; and
receiving the second display control data from the computer to display the second display control data onto the display unit of the first telephone terminal in the telephone exchange apparatus.
